(19) United States
(12) Patent Application Publication
(10) Pub. No.: US 2004/0166255 A1
(43) Pub. Date: Aug. 26, 2004

(54) Substrate for core and tubewinding

(76) Inventor: Peter D. Pierce, Washington Crossing, PA (US)

Correspondence Address: Cynthia L. Foulke, NATIONAL STARCH AND CHEMICAL COMPANY, 10 Finderne Avenue, Bridgewater, NJ, 08807-0500, US

(21) Appl. No.: 10/372,418

(22) Filed: Feb. 24, 2003

(51) Int. Cl. B32B 1/08; B31C 13/00; B32B 31/20; C09J 5/02; B31C 11/04

(52) U.S. Cl. 428/34.1; 156/308.8; 156/497; 156/425

(57) ABSTRACT

An apparatus and method for manufacturing a core or tube. The apparatus comprises a means for reactivating an adhesive present on at least one surface of at least one ply.

### FIELD OF THE INVENTION

The invention relates to the field of core and tubewinding. More particularly, the invention relates to a substrate material used in the manufacture of tube and cores which has applied thereon an adhesive. The adhesive is reactivated during core and tubewinding operations.

### BACKGROUND OF THE INVENTION

Paper tubes for use as winding cores, composite cans or tubes for packaged goods, concrete forms, etc. are generally produced from two or more plies of paper, fed either by a web or from a stack of precut sheets. Adhesive is applied between the plies, and the paper is then wound around a stationary steel mandril. Belts twisted around the mandril and plies provide compression and drive the process, pulling the webs and feeding the wound tube forward. At some point located past the end of the steel mandril, the wound tube is cut, and the finished tube is then ready for use or for the next step in a converting process.

While the limiting factor in this process has historically been the speed of the equipment, increased demand for higher output of the converting equipment, and improvements in equipment engineering and fabrication, have now made the adhesive systems—almost exclusively waterborne adhesives in North America—the limiting factor in the converting process. Specifically, it is necessary that the applied adhesive be properly “set” by the time the tube is cut and further handled or processed. For this to happen, enough water must be removed from the adhesive itself (through absorption or evaporation, or a combination of the two) to form a sufficiently strong and cohesive bond. Due to the speeds of newer and faster equipment, there is not enough time available in the process between the adhesive application and the cutting station for this to occur, and so machine speed must be slowed down.

Aside from the conventional “unaided” converting process, methods of removing water from the adhesive system, include hot-air blowers, ovens using heating elements, hot presses or forms that intimately contact the wound tube, heat lamps and other infrared heating methods, and microwave irradiation. Drying methods employing heated parts, hot air, and infrared lamps are often very inefficient processes since most of the energy used in creating the heat is “wasted” due to environmental loss and the necessity of transferring the heat through the substrate(s) and into the adhesive layer.

A problem inherent in many of these methods is that they must also provide heat to the paper plies. This is unavoidable, since many of these methods of transferring heat to the adhesive cannot reach the adhesive layer without first heating the outer layer(s) of paper. The energy of heating is transferred to the entire wound tube; this can affect the moisture content of the paper quite radically by drying the paper in the process of heating the tube. Once the moisture content of the paper in the finished tube re-equilibrates with the surrounding environment, the tube may shrink, expand, warp, or otherwise deform, which often makes the tube unsuitable for further use or processing. In addition, proximity to high heat sources (such as infrared lamps or heated elements) can cause physical damage (such as scorching) to the plies themselves.

Many other methods of heating and drying the adhesive also increase the temperature of the area and equipment surrounding the process. Hot-air blowers and oven elements generate a great deal of heat, posing a potential safety hazard. In many cases, because of the amount of heat necessary to affect the desired level of drying, the work area may become uncomfortably warm or even hazardously hot. Equipment (particularly the equipment generating the heat) may become dangerous to touch. The risk of ignition or other fire-related issues is also increased in such circumstances.

A need exists for alternative methods of manufacturing cores and tubes to enable the faster, more economical and safer production thereof. The current invention fulfills this need.

### SUMMARY OF THE INVENTION

The invention provides a paper core or tube comprising one or more plies of paper or paperboard bonded together with an adhesive that has been preapplied to the paperboard plies prior to tube/core formation. Useful reactivatable adhesives include but are not limited to hot melt adhesives and waterborne adhesives.

One embodiment of the invention is directed to a method of preparing a single or multi-ply core or tubular container having at least a first ply wrapped into a tubular shape and having an inner surface and an outer surface. The core or tubular container may further comprise at least a second ply wrapped into a tubular shape and having an outer surface positioned in face-to face contact with the inner surface of the first ply. At least one of the plies is preferably formed of a fibrous paperboard. Adhesive that has been pre-applied to at least one surface of at least one substrate comprising the tubular laminate. The core may desirably include additional body plies, e.g. up to about 30 plies or more.

Another embodiment of the invention is directed to a method of manufacturing multiply cores or tubular containers. The method comprises advancing a continuous first ply and continuous second ply towards a shaping mandril wherein at least one of those plies comprises a pre-applied adhesive. The adhesive composition is present on at least one or both surfaces of the first and/or second ply. The adhesive present on the at least one ply is activated before the first and second plies are wrapped around the shaping mandril to create the core. The first and second plies may be adhered together by passing the two plies in face-to face contact prior to the wrapping step or they may be adhered during the wrapping stage.

Still another embodiment of the invention is directed to stock ply materials use in the manufacture of tube and cores. The continuous ply materials have pre-applied to at least one surface thereof an adhesive. The adhesive formulations may be pre-applied in a continuous or discontinuous, e.g., as evenly spaced beads or dots, manner depending on surface area and coating weight desired. Particular patterns may be used to optimize substrate/adhesive contact. Depending on the adhesive, the bead size, thickness, distance apart and pattern will vary. The adhesive may be pre-applied to the substrate by any method known in the art, and include, without limitation roll coating, painting, dry-brushing, dip coating spraying, slot-coating, swirl spraying, printing (e.g., ink jet printing), flexographic printing, extrusion, atomized spraying, gravure (pattern wheel transfer), electrostatic, vapor deposition, fiberization and/or screen printing. Yet another aspect of the invention is directed to apparatus for manufacturing a core or tube. Machines for manufacturing single ply, 2-ply and multi-ply tubes and cores are encompassed by the invention. The apparatus includes a means for reactivating an adhesive preapplied to at least one surface of a continuous body ply material.

Also encompassed are tube and corewinding methods were an adhesive comprising an energy absorbing ingredient is applied in the conventional manner, i.e., during the core or tubewinding process, and a radiant energy source is used to facilitate the performance, adhesion, and set speed of the adhesive.

### BRIEF DESCRIPTION OF THE DRAWING FIGURES

Drawing FIGS. 1-6 illustrate several embodiments of the invention. In the drawing Figs., the type and predetermined location(s) of the reactivating means (3) depends on the number of plies being wound and the type of reactivatable adhesive pre-applied to the plies.

FIGS. 1 and 2 show embodiments of machines that can be used in the manufacture of 2-ply (FIG. 1) and single ply (FIG. 2) tubes and cores wherein the pre-applied adhesive is reactivated using, e.g., a near infrared radiant energy source.

FIGS. 3-6 show several embodiments of machines that can be used in the manufacture of 2-ply (FIGS. 3, 5 and 6)) and single ply (FIG. 4) cores and tubes wherein the pre-applied adhesive is activated using ultrasonic waves.

### DETAILED DESCRIPTION OF THE INVENTION

The process of manufacturing cores and tubes can be greatly accelerated by using stock materials, more particularly continuous plies that have adhesive preapplied to at least one surface thereof. The use of materials comprising a reactivatable adhesive eliminates the application of adhesive on the production line and the problems associated therewith (e.g., adhesive selection, processing, troubleshooting, inventory, and maintenance of adhesive application equipment) and allows core winding equipment to be run at higher machine speeds, increasing the total output of finished product.

Reactivation, as this term is used herein, refers to an adhesive that resides on at least a portion of at least one substrate to be bonded to a second substrate. The adhesive present on the substrate is thereafter reactivated (by e.g., exposure to a source of radiant energy, exposure to moisture), brought in contact with a second substrate and allowed to cool or solidify, thereby bonding the two substrate together. The application of the adhesive onto a substrate for later activation or “reactivation” is referred to herein, and in the art as a “pre-applied” adhesive. The adhesive present on the substrate may be reactivated anytime after initial application to the substrate for bonding to a second substrate.

The terms substrate and stock are used interchangeable herein.

Reference to a “first” and a “second” substrate is for convenience. It is to be understood that the first and second substrates may be two separate and distinct substrates which may comprise the same material or a different material, or may be two different areas (e.g. sides) of a single contiguous substrate which is usually the same material but may be different (e.g., if the ply is a laminate).

The manufacture of both consumer (e.g., toilet paper rolls, food containers, and the like) and industrial (e.g., concrete forms, spool for cable wire, and the like) cores and tubes are encompassed by the invention. As used herein, a core is a paper or paperboard construction around which material may be wound. The material can be tissue or towel, carpet, textile, plastic film, paper or any other material that is wound around a core. A tube is a container that is used to transport or store various dry foods, refrigerated foods or dough, oils and other liquids and is also used for various industrial applications, e.g., concrete column forming tubes, caulking tubes.

Cores or tubes can be made using single or multiple plies of substrates. Typically about 2 to about 7 plies are used in cores/tubes for consumer applications and from about 10 to about 20 plies or more are used in cores/tubes for industrial applications.

When making paper cores or tubes in accordance with the invention, the selection and application of the adhesive is not critical to the practice of the invention, as long as the adhesive can be reactivated. Adhesives reactivatable by application of a NIR energy source, adhesives reactivatable by application of ultrasonic waves and adhesives reactivated by moisture are particularly preferred for use in the practice of the invention.

It has been discovered that when a suitable energy-absorbing ingredient is added to a conventional adhesive, reactivation upon short duration of radiant energy can be achieved. Energy-absorbing ingredients contemplated for use in the practice of the invention are commercially available and include, but are not limited to dyes, pigments and fillers. Examples include carbon black, graphite, Solvent Red (2′,3-dimethyl-4-(2-hydroxy-naphthylazo)azo-benzene), Solvent Green, dyes such as Forest Green and Royal Blue masterbatch dye available from Clariant, cyanine-based dyes, oxides such as such as titanium dioxide, and metals such as antimony, tetrakis)dialkylaminophenyl)aminium dyes, cyanine dyes, squarylium dyes and the like.

Pigments, such as carbon black and graphite, are particulate in nature and will usually have somewhat of a spherical shape with average particle sizes in the range of about 0.01 to about 7 microns. Pigment particles aggregate, so aggregate size will be larger. The pigment aggregate size in hot melt adhesives will preferably be smaller than about 500 microns. Aggregate sizes of less than about 100 microns are preferred, more preferably smaller than about 50 microns.

A wide variety of organic NIR triggers are described in the literature and are available for use in the practice of the invention. Such compounds include cyanine, metal complexes, quinone, azo, radical multiphenylmethane, perylene, aromatic annulenes, fluorenylium. Such triggers possess various absorption characteristics. For example, halogen substituted 1,4,5,8-tetraanilioanthraquinones have excellent transmittance in the vicinity of 860 nm and can absorb NIR in other ranges. Another example is squaraine, which is characterized by intense narrow absorption bands at relatively long wavelength. Also specifically designed phthalocyanine compounds have been demonstrated exhibiting high transmittance to visible light and offering high efficient cut of near infrared.

Preferred energy-absorbing ingredients for use in the practice of the invention are broad band near IR absorbers such as Epolight 1125 (Epolene, Inc), SDA6248 (H.W. Sands Corp.), SDA2072 (H.W. Sands Corp.) and carbon black. Carbon black can be purchased from Cabot under trade name of Monarch, Regal, Black Pearl, and Elftex, or Degussa (FW series), or from Columbian Chemical Company (Raven Series). Carbon black can be manufactured by different methods such as the furnace black method, the gas (channel) black method, and the lamp black method. The key parameters affecting the radian energy absorption of carbon black prepared by these various methods are average primary particle size, surface chemistry and aggregate structure.

Energy absorbing ingredients for use in the practice of the invention will typically have an absorption in the range of from about 400 nm to about 100,000 nM, more preferably from about 700 nm to about 10,000 nm, even more preferably from about 750 nm to about 5000 nm.

Suitable energy-absorbing ingredients for use in reactivatable adhesives of the invention may be identified by blending any desired adhesive with a chosen additive of various particle size and various amounts. Any conventional method of blending the energy-absorbing ingredient with the adhesive such as through use of a paddle mixer or high shear rotor stator mixer such as Ross ME-100LC extruder, as would be apparent to the skilled practitioner, may be used to prepare the adhesive compositions of the invention. The starting adhesive and the adhesive containing the energy-absorbing ingredient then are compared by heating samples of each with a light from a radiant heat source. The samples are tested for reactivation efficiency and bonding performance. Reactivation efficiency is the ability the adhesive to become molten in a short period of time. Suitable additives are those that reactivate quickly and exhibit acceptable bond strength. Preferred are thermoplastic adhesives which, when pre-applied to a substrate, re-activates with a short duration of exposure to radiant energy, preferably less that about 10 seconds, more preferably less than about 5 seconds, even more preferably less than about 3 seconds, and provides acceptable bond force after a short period of compression or cooling, preferably a period of less that about 30 seconds, more preferably less than about 15 seconds.

Radiant energy can be supplied by a number of sources, as will be apparent to the skilled practitioner. Examples include lasers, a high pressure xenon arc lamp, a coiled tungsten wire, ceramic radiant heater and tungsten-halogen lamps. Preferred for use is radiant energy within the near infra-red (NIR) region. Peak wavelengths of from 400 nm to about 100,000 nm are contemplated for use. More typically, peak wavelengths of from 700 nm to about 10,000 nm, most typically from about 750 nm to about 5000 nm, will be used in the practice of the invention. Commercial sources of equipment capably of generating radiant heat required for use in the practice of the invention include Research Inc. (Eden Prairie, Minn.), Chromalox (Ogden, Utah), DRI (Clearwater, Fla.), Advent Electric Inc. (Bridgeport, Pa.), and Glo-Quartz Inc. (Mentor, Ohio). Both coherent and non-coherent sources may be used.

While traditional adhesives are primarily transparent to NIR, the adhesives of the invention absorb and reflect the energy. This allows for quicker reactivation, while hindering the energy from impinging on the substrate surface thereby creating a weak thermal boundary layer and extending the set time.

The reactivation efficiency, i.e., the ability of the adhesive to become molten in a short period of time will depend on the power of the device and the distance of the light source from the adhesive. Reactivation time depends on receptivity of the adhesive, which depends on the coating weight or thickness of the adhesive and the energy flux density that the radiant source can supply to the adhesive (e.g., intensity per unit area). Energy flux density refers to the distance, focal point, power and intensity of the lamp or power source.

Preferably, the reactivatable adhesives are formulated to reactivate to a temperature of at least about 200° F., more preferably to a temperature of at least about 250° F. upon exposure of less than about 1200 watts/sq inch of near infrared energy for a period of less that about 10 seconds, more preferably less than about 5 seconds, even more preferably less than about 3 seconds.

The adhesive formulations of the invention may be pre-applied in a continuous or discontinuous, e.g., as evenly spaced beads or dots, manner depending on surface area and coating weight desired. Particular patterns may be used to optimize substrate/adhesive contact. Depending on the adhesive, the bead size, thickness, distance apart and pattern will vary. The adhesive may be pre-applied to the substrate by any method known in the art, and include, without limitation roll coating, painting, dry-brushing, dip coating spraying, slot-coating, swirl spraying, printing (e.g., ink jet printing), flexographic, extrusion, atomized spraying, gravure (pattern wheel transfer) electrostatic, vapor deposition and/or screen printing. The method of pre-application to the substrate is not critical to the practice of the invention.

The reactivation efficiency, i.e., the ability of the adhesive to become molten in a short period of time will depend on the power of the energy source (e.g., lamp or laser), the distance of the energy source from the adhesive, the number of energy sources and the like as will be apparent based on the disclosure herein. Reactivation time depends on receptivity of the adhesive, which depends on the coating weight or thickness of the adhesive and the energy flux density that the radiant source can supply to the adhesive (e.g., intensity per unit area). Energy flux density refers to the distance, focal point, power and intensity of the lamp or power source.

Preferably, the reactivatable adhesives are formulated to reactivate to a temperature of at least about 200° F., more preferably to a temperature of at least about 250° F. upon exposure of less than about 1200 watts/sq inch of near infrared energy for a period of less that about 10 seconds, more preferably less than about 5 seconds, even more preferably less than about 3 seconds.

The type of adhesive that can be reactivated in accordance with the invention is not particularly limiting or critical to the practice of the invention. Reactivatable adhesives encompassed by the invention include but are not limited to hot melt adhesives, waterborne adhesives, solvent borne adhesives, moisture curable adhesives, ultraviolet curable adhesives, blocked urethane systems, epoxy based adhesives, and adhesives comprising an encapsulated cureative or the like. Thermoplastic and hot melt adhesives are particularly useful when formulated for pre-application and subsequent later reactivation. The adhesive compositions may be used for the bonding of paper, metal, plastics, wood, and combinations thereof. Adhesive may be coated to either or both surfaces of a substrate to be bonded. It will be apparent that a thermoplastic adhesive present on a substrate may be applied to a substrate in the form of a waterborne emulsion or solution.

Any conventional polymers suitable for use in formulating adhesives, as are well known to those skilled in the art, may be used in the practice of the invention. Typical thermoplastic adhesive formulations to which an energy absorbing additive may be added in accordance with the invention comprise a wax or diluent, a thermoplastic polymer and a tackifier. In all cases, the adhesive may be formulated with tackifying resins, plasticizers, waxes and/or other conventional additives such as antioxidants and stabilizers in varying amounts as are known to those skilled in the art and as required for particular formulations. Hot melt adhesives may be prepared using techniques known in the art. Typically, the adhesive compositions are prepared by blending the components in the melt at a temperature of about 100° to 200° C. until a homogeneous blend is obtained, usually about two hours. Various methods of blending are known and any method that produces a homogeneous blend is satisfactory. Compositions of other types of adhesive formulations (e.g., waterborne formulation) and methods of preparation thereof would be apparent to the skilled practitioner.

The energy-absorbing ingredient may be added, with stirring, any time during the preparation of the base adhesive, or following preparation of the base adhesive. The amount added will depend on the type of additive the size and the dissolution or dispersion properties. The additive is added in an amount effective to reactivate (melt) the adhesive upon exposure to short durations (typically less that 10 seconds) of radiant energy. Typically, the additive will be present in an amount of about 0.001 to about 10 parts per 100 parts of the adhesive composition. Reactivatable adhesives containing an energy-absorbing ingredient are described in copending commonly assigned U.S. application Ser. No. 09/933,279, entitled “Reactivatable adhesives” and in commonly assigned and concurrently filed application Serial No. (ATTY docket No. 2090), entitled “Reactivatable adhesive,” the disclosures of which are incorporated herein in their entireties by reference.

Adhesives reactivatable by the application of ultrasonic waves are described in commonly assigned and concurrently filed application Serial No. (ATTY docket No. 2091), entitled “Reactivation of pre-applied adhesives by ultrasonic waves,” the disclosure of which is incorporated herein in its entirety by reference.

In embodiments where the adhesive is sensitive to ultrasonic waves the invention involves bringing one substrate in contact with the adhesive present on a second substrate, subjecting the first and/or second substrate to ultrasonic compression for a time sufficient to melt/reactivated the adhesive and allowing the adhesive to solidify whereby the first substrate is bonded to the second substrate. In embodiments were reactivation occurs by exposure to ultrasonic energy, the adhesive present on the first substrate may be reactivated either before or after being contacted with the second substrate to be bonded thereto.

The re-activation and performance of ultrasonically reactivatable adhesives is achieved by incorporating into an adhesive energy-absorbing ingredients that are sensitive to ultrasonic energy. Examples include thermoplastics, thermosets, low Tg polymers, composites and blends thereof.

The reactivation efficiency of an adhesive refers to the ability of the adhesive to reactive, e.g., become molten in a short period of time. Reactivation efficiency will depend on the compression pressure, the power and frequency of the ultrasound, the geometry and contact area of the ultrasonic horn and the exposure time.

Preferred formulations for the adhesive layer will comprise styrene-butadiene-styrene copolymers, ethylene vinyl acetate, a wax and a tackifier. Elastomeric adhesives with glass transition temperatures below 20° C., or semicrystalline polymers with a melting temperature of below about 20° C. are particularly preferred.

Preferred reactivatable adhesive will reactivate upon exposure to ultrasonic energy having a frequency of from about 15-kilohertz to about 60 kilohertz, more preferably from about 20 kilohertz to about 40 kilohertz. Preferably, the reactivatable adhesives are formulated to reactivate to a temperature of at least about 200° F., more preferably to a temperature of at least about 250° F. upon exposure of less than about 2000 watts/sq inch of ultrasonic energy for a period of less that about 10 seconds, more preferably less than about 5 seconds, even more preferably less than about 3 seconds.

Ultrasonic generators used in the practice of the invention generally and conventionally comprise a transducer, a booster and horn. A booster is typically used to amplify and boost energy. Ultrasonic horns are known in the art and include rectangular horns and rotary horns of cylindrical shape. Preferred geometry for use in the practice of the invention is to press the ultrasound horn onto substrate layers where the adhesive layer is sandwiched in the middle. Alternatively, the substrate may be pressed into the horn. The ultrasonic energy will typically be used at a frequency of from about 15 kilohertz to about 60 kilohertz, more preferably from about 20 kilohertz to about 40 kilohertz.

Also useful for pre-application are water remoistenable adhesives. Water remoistenable adhesives are dry adhesive compositions which, when moistened with water, develop an adhesive tackiness. The current invention provides substrates comprising a water remoistenable adhesive which, having been applied to a substrate and allowed to dry, is capable, upon reactivation with moisture, of bonding the substrate to a second substrate. The waterbased adhesive is applied to a paper substrate stock material and dried. The substrate coated with dried adhesive is then passed to further processing. Waterbased adhesives contemplated for use may be comprised of synthetic or natural ingredients. If desired, the adhesive may be foamed, such as by mechanical agitation with air, prior to application to the substrate. As water present in adhesives often causes slow drying and can cause the substrate to curl or bend, addition of air bubbles to the adhesive can significantly reduce moisture content without affecting adhesive performance even after having been dried and reactivated. Benefits of using a foamed adhesive include improved economics and performance, such as reduced penetration into substrates, reduced moisture and faster set times.

In the process of the invention, adhesive is applied to a substrate in the liquid state and allowed to dry, i.e., solidify, thereon. The adhesive present on the first substrate is thereafter reactivated or remoistened back to a liquid state, by contacting the dry adhesive with moisture (e.g., water, mist, steam, or the like). The substrate is brought in contact with the second substrate and the adhesive allowed to dry or solidify, thereby bonding the two substrates together. In this embodiment, the terms remoistenable and reactivatable are used interchangeably.

Adhesives that can be used in the practice of this particular embodiment include synthetic resins, natural resins, natural rubbers, starches or dextrins. The adhesives of the invention may be in the emulsion or solution form. Preferred adhesives comprise at least one resin emulsion, and may also comprise at least one filler or other additive. A preferred resin is polyvinyl acetate. Particularly preferred are foamed adhesives comprising a blend of two or more polyvinyl acetate emulsions are contemplated and the use of homopolymers, copolymers and mixtures thereof are encompassed.

Typically, the foamed adhesive comprises more than about 30%, more typically from about 50% by weight to about 100%, more preferably 55% by weight to about 85% by weight of the resin emulsion component and from 0% by weight to about 50% by weight, more typically from about 0% to about 20% by weight of filler and/or other conventional additives.

Resin emulsions that may be used in the practice of the invention are emulsions and mixtures thereof. Adhesives comprising polyvinyl acetate and/or polyvinyl alcohol are preferred for use in the practice of the invention. Mixtures of two or more polyvinyl acetates and mixtures of polyvinyl acetate and other polymer emulsions comprising vinyl acetate and other monomers, including but not limited to ethylene and acrylic monomers, are encompassed. Polyvinyl acetate may be prepared using a continuous or a batch process. Polyvinyl acetate emulsion mixtures wherein the polyvinyl acetates used are prepared by one method or by both methods may be used. Such polyvinyl acetates are commercially available from National Starch and Chemical, Bridgewater, N.J.

The adhesive may also contain a filler or other conventional ingredients. The addition of a filler allows for foam generated to remain consistent and stable for several hours. Suitable fillers are those fillers known in the art as adhesive fillers and include polysaccharides, calcium carbonate, clay, mica, nut shell flours, silica, talc and wood flour.

Polysaccharides useful in the invention include starch, dextrin, cellulose, gums or combinations thereof. Particularly useful are the starches and dextrins including native, converted or derivatized. Such starches include those derived from any plant source including maize (corn), potato, wheat, rice, sago, tapioca, waxy maize, sorghum and high amylose starch such as high amylose corn, i.e. starch having at least 45% amylose content by weight. Starch flours may also be used. Also included are the conversion products derived from any of the former bases, such as, for example, dextrins prepared by hydrolytic action of acid and/or heat; fluidity or thin boiling starches prepared by enzyme conversion or mild acid hydrolysis; oxidized starches prepared by treatment with oxidants such as sodium hypochlorite; and derivatized or modified starches such as cationic, anionic, amphoteric, non-ionic, crosslinked and hydroxypropyl starches. Other useful polysaccharides are cellulose materials such as carboxymethylcellulose, hydroxypropyl cellulose and hydroxypropyl methylcellulose, and gums such as guar, xanthan, pectin and carrageenan may also be used in the practice of the invention. Modified starches include, but are not limited to, those modified with an alkyl succinic anhydride. Preferred are octenyl succinic anhydride (OSA) and dodecenyl succinic anhydride (DDSA) modified starches or dextrins.

The adhesive may also preferably contain a surface-active agent. Examples of surface-active agents include anionic, cationic, amphoteric, or nonionic surfactants, or mixtures thereof. Suitable anionic surfactants include, alkyl sulfonates, alkylaryl sulfonates, alkyl sulfates, sulfates of hydroxylalkanols, alkyl and alkylaryl disulfonates, sulfonated fatty acids, sulfates and phosphates of polyethoxylated alkanols and alkylphenols, and esters of sulfosuccinic acid. Suitable cationic surfactants include, alkyl quaternary ammonium salts, and alkyl quaternary phosphonium salts. Suitable non-ionic surfactants include the addition products of 5 to 50 moles of ethylene oxide adducted to straight-chain and branched-chain alkanols having 6 to 22 carbon atoms, alkylphenols, higher fatty acids, higher fatty acid amines, primary or secondary higher alkyl amines, and block copolymers of propylene oxide with ethylene oxide, and mixtures thereof. Suitable amphoteric surfactants include disodium lauramino propionate. Surfactants useful in the practice of the invention include surfactants modified with, e.g., alkyl succinic anhydrides, such as OSA. When used, the surface active agent will typically be added in amounts up to about 20% by weight, based on the foamable composition as a whole. More usually amounts of from about 0.05 to about 20% by weight, and preferably from about 0.1 to about 2% by weight.

Other additives typical of adhesive compositions may be added to the foamable composition of the invention. Said additives include, but are not limited to, humectants, flavorants, crosslinkers, plasticizers, acids, waxes, synthetic resins, tackifiers, defoamers, preservatives, bases such as sodium hydroxide, dyes, pigments, UV indicators, and other additives commonly used in the art.

Examples of humectants include those conventionally used in aqueous adhesives such as sugars (sucrose, fructose), urea, glycols, glycerine and salts such as sodium chloride, sodium nitrate and calcium chloride. The humectant will generally be used in amounts of from about 1.0 to about 20.0%.

Typical preservatives for use herein include those conventionally used in aqueous adhesives such as benzoates, amides and fluorides such as sodium fluoride. Also included are the hydroxybenzoic acid esters such as p-hydroxybenzoic acid methyl ester or p-hydroxybenzoic butyl ester. Commercially available preservatives that may be used in the practice of the invention include KATHON LXE sold by Rohm & Haas Company and Nipacide OBS sold by Clariant. The preservative will generally be included in amounts of from 0.05% to about 0.2% by weight.

The foamable adhesive composition of the invention is foamed by the addition of energy, by means known in the art such as, but not limited to, by mechanical and/or chemical means. Air or other gases are added to the foamable adhesive composition along with the addition of said energy to produce a stable, consistent foamed adhesive. Preferably air is used to produce the foamed adhesive. The adhesive foam may be produced by mechanical means such as mechanical stirring or agitation, introduction of gases or by chemical means.

The amount of air dispersed in the adhesive can vary depending on the particular formulation, but will generally be from about 5% (by volume) up to about 75% (by volume) or greater, more typically from about 10 up to about 50% (by volume), even more typically from about 20 up to about 35% (by volume).

The adhesive may be applied by any method known in the art. The adhesive product can be applied to a substrate by a variety of methods including coating or spraying in an amount sufficient to cause the article to adhere to another substrate upon reactivation. The foamed adhesive formulations of the invention may be pre-applied in a continuous or discontinuous, e.g., as evenly spaced beads or dots, manner depending on surface area and coating weight desired. Particular coating patterns and thickness may be chosen to optimize substrate/adhesive contact. The adhesive may be pre-applied to the substrate by any method known in the art, and include, without limitation slot-coating, swirl spraying, extrusion, contact extrusion, atomized spraying, smooth roll, grooved roll, stencil, gravure (pattern wheel transfer), screen printing. Roller and stencil applicators are particularly preferred for use in applying the adhesive a paper substrate. Typically the substrate material is coated with from about 3 to about 4 wet mils of foamed adhesive.

The method of pre-application of the adhesive to the substrate is not critical to the practice of the invention. The adhesive is applied to a substrate while in its liquid state and allowed to dry to harden the adhesive layer. The adhesive can be allowed to air dry or can be dried by other conventional means, such as with the use of ovens.

The reactivation efficiency, i.e., the ability of the adhesive to become wetted or moistened in a short period of time will depend on the water solubility of the components in the adhesive formulation. Reactivation time depends on receptivity of the adhesive, which depends on the coating weight or thickness of the adhesive and the amount of water applied.

In the practice of the invention, exposure to moisture is typically for periods of less than about 5 seconds. Pressure is typically applied for periods of less than about 30 seconds. Typically water is used to wet the surfaces. The water may be in the form of a mist, spray, saturated material (e.g., wet sponge) or steam.

There are two basic methods for making a core, convolute winding and spiral winding. Convolute winding uses a web of paper that is as wide as the resulting core is long. A mandril spins and winds the paper onto itself forming the core. While adhesive is conventionally applied in a continuous manner to the ply material as the core is wound, it has now been discovered that adhesive can be pre-applied to the stock ply material during the manufacture thereof. Spiral winding comprises continuous winding of 2 or more plies around a mandril at an angle causing the length of the core to grow as the plies are wound. Methods of preparing helically wound cores/tubes and “convolute” cores/tubes are encompassed by the invention.

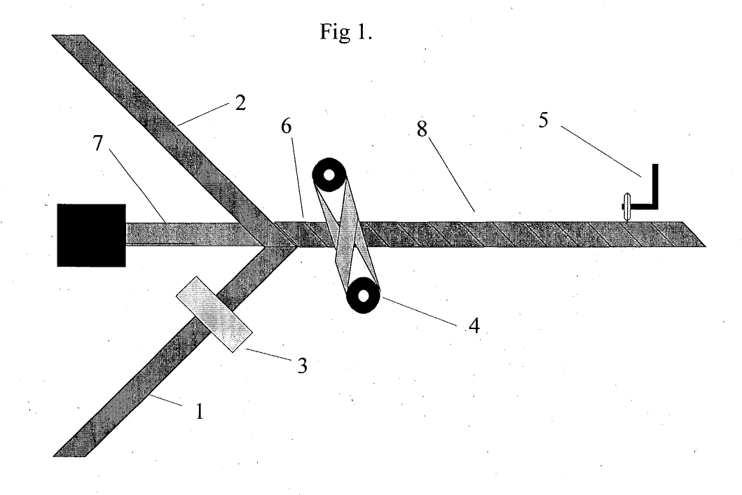

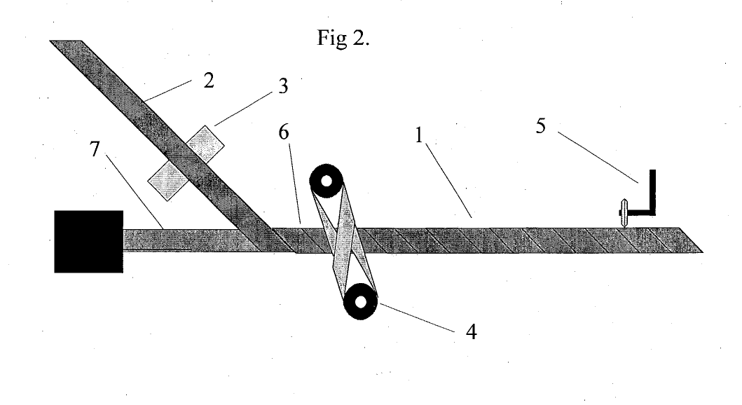

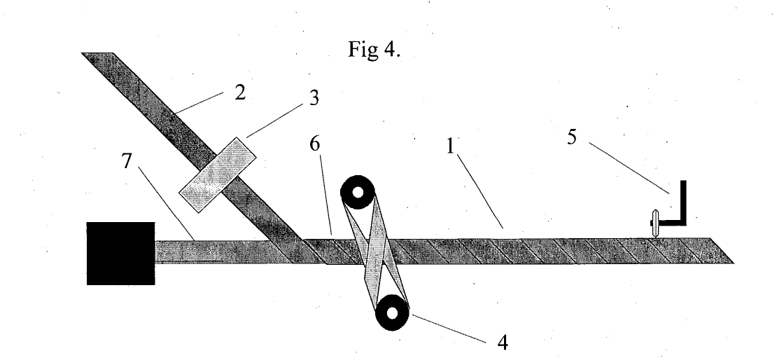

Drawing FIGS. 1-6 illustrate single and two-ply spiral-wrap tube winding apparatus that may be used in the practice of the invention. In this configuration, a core/tube is produced from a single ply (FIGS. 2 and 4) or from two plies (FIGS. 1, 3, 5 and 6) of paper fed either by a web or from a stack of precut sheets. At least one surface of at least one ply (e.g., inner ply (2) and/or outer ply (1)) comprises a pre-applied adhesive. The plies are then wound around a stationary mandril (7). Belts (4) twisted around the mandril and plies provide compression and drive the process, pulling the webs and feeding the wound tube forward. At least one means (3) for reactivating the adhesive present on at least one surface of said at least one ply is located at least one predetermined location. At a point located past the end of the mandril, the wound tube is cut by the cutting saw (5), and the finished tube is then ready for use or for the next step in a converting process.

FIG. 1 illustrates an apparatus for manufacturing 2-ply tubes and cores wherein an adhesive comprising an energy absorbing ingredient (e.g. an organic dye, pigment or the like) is preapplied to the inner surface of the outer ply. A reactivation means (3) such as a NIR lamp or laser is placed at a predetermined location prior to the plies being wound. In the illustration, adhesive is present on the inner surface of the outer ply (1) and thus the reactivation means (3) is located over the inner surface of the outer ply. It is to be understood that the adhesive could alternatively be on the outer surface of the inner ply (2) surface and the reactivations means located at said inner ply surface (e.g. over the outer surface of the inner ply). Alternatively, adhesive may be present at predetermined locations of both inner and outer ply surfaces. In such case, two reactivation means may be used or the reactivation means may be place at the site where the two plies come together and meet. All embodiments are encompassed by the invention.

In the apparatus shown in FIG. 1, it will be appreciated that the adhesive present on the inner surface of the outer ply may, alternatively, be a remoistenable adhesive and the reactivation means may generate a fine aqueous mist or the like.

FIGS. 2 and 4 show an apparatus for the manufacture of single ply tubes and cores wherein adhesive pre-applied to the inner surface of an edge of the ply material. In single ply core and tube manufacture, adhesive is extruded on the edge and the paper is bonded via an overlap with an adjacent edge. As the pre-applied adhesive of the invention can be precisely applied, squeeze out is eliminated and any bulge of the overlap area is minimized. In the embodiment of FIG. 2 the pre-applied adhesive comprises an energy absorbing ingredient (e.g., an NIR absorbing ingredient) and the reactivation means (e.g., a NIR lamp or laser) is located over the inner surface of the ply. In the embodiment of FIG. 4, the pre-applied adhesive is sensitive to ultrasonic energy and the reactivation means is located over the outer surface of the ply so as to subject the substrate to ultrasonic compression.

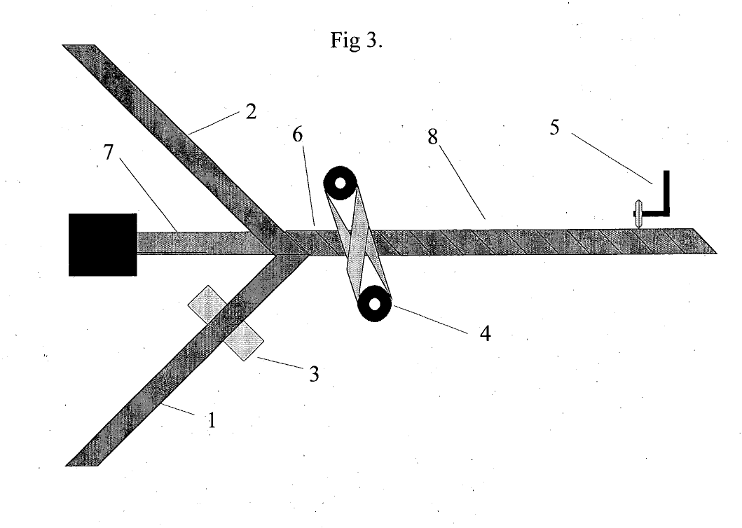

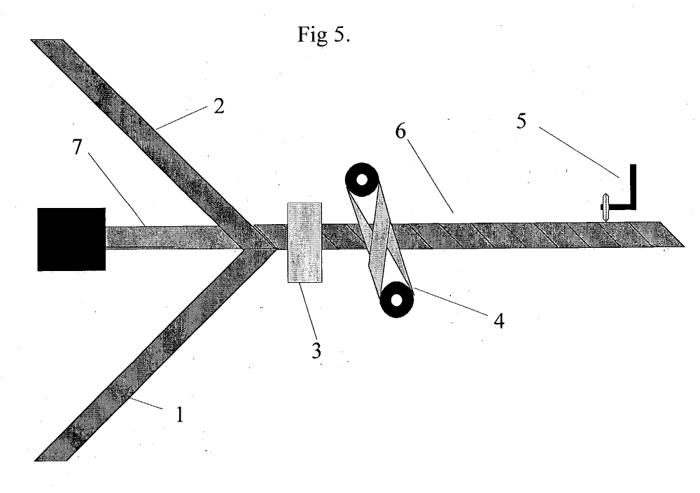

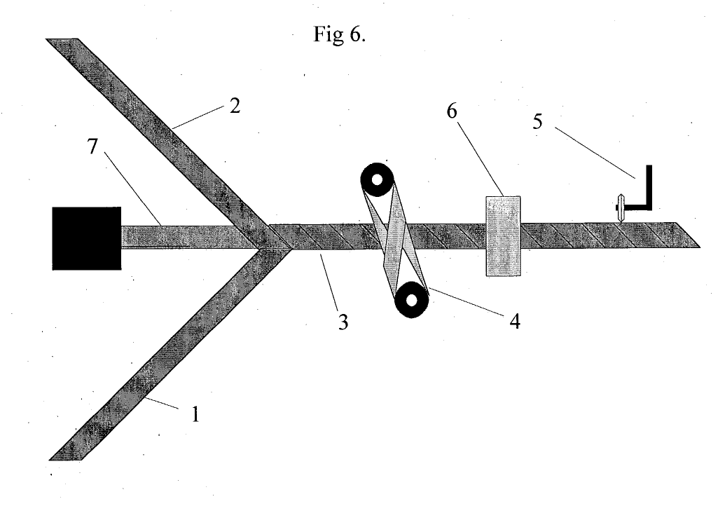

FIGS. 3, 5 and 6 illustrate various embodiments for manufacturing 2-ply tubes and cores wherein the adhesive to be reactivated is sensitive to ultrasonic energy. In FIG. 3, the reactivatable adhesive is located on the inner surface of the outer ply and the reactivation means (e.g., an ultrasonic generator comprising an ultrasonic horn) is located over the outer surface of the outer ply. In FIGS. 5 and 6, the reactivatable adhesive is located on the inner surface of the outer ply and/or the outer surface of the inner ply (i.e., the adhesive formula is sandwiched between the substrate plies) and the plies are wound prior to reactivation. In FIG. 5, the reactivation means is located prior to the belts (4). In FIG. 6, the reactivation means is located after the belts (4).

The embodiments shown in the drawing Figures are for illustration only. Other embodiments would be readily apparent to the skilled artisan.

When adhesive is pre-applied to a core or tube substrate rather than being applied on the production line, process improvements that can yield faster and more efficient output and greater control can be realized. The net result is a faster, more efficient, and more controlled converting process that is cost-effective and environmentally sound. Moreover, many adhesive-related issues, including adhesive selection, processing, troubleshooting, inventory, and maintenance of adhesive application equipment can be avoided.

The invention provides a method of preparing a single or multi-ply core or tubular container. The core or tube comprises at least a first and, preferably, at least a second ply. The core/tube is formed using plies of stock material that has pre-applied thereon an adhesive. Upon reactivation, the adhesive, which may be pre-applied to the inner surface of the first ply and/or the outer surface of the second ply, adheres the two plies together. At least one of the plies is preferably formed of a fibrous paperboard. The core may desirably include additional body plies. Typically about 2 to about 7 plies are used in cores/tubes for consumer applications and from about 10 to about 20 plies or more are used in cores/tubes for industrial applications.

The invention provides a method of manufacturing multi-ply cores. The method comprises advancing a continuous first ply and continuous second ply towards a shaping mandril wherein at least one of the plies has a pre-applied adhesive present thereon. A reactivation means reactivates the adhesive whereby the first and second plies are adhered together with the adhesive. The first and second plies are wrapped around the shaping mandril to create the core. The first and second plies may be adhered together by passing the two plies in face-to face contact prior to the wrapping step or they may be adhered during the wrapping stage.

The invention also provides an apparatus for manufacturing a core/tube. The apparatus includes a means for reactivating an adhesive present on at least one surface of the body ply. The adhesive reactivation means is located adjacent to one surface of a body ply and reactivates the adhesive present on the surface of the body ply. A shaping mandril is positioned to adhere the plies together with the adhesive to form a tubular shape. Advantageously, the apparatus further includes a cutting station adjacent to one end of the mandril for cutting the tubular shape into discrete container lengths.

It has been discovered that reactivating an adhesive present on the core/tube ply material rather than applying adhesive during tube- and corewinding operations enables a substantial increase in process speeds by removing the adhesive applying step, avoiding adhesive-related issues, including adhesive selection, inventory, processing, trouble shooting and down time during which the production line must be stopped in order to identify and fix an adhesive problem.

This can be achieved in a safe and environmentally sound manner, without requiring significant process changes or re-engineering, and without an increased chance of physical change or damage to the finished tube or core.

The invention is further illustrated by the following non-limiting examples.

### EXAMPLES

### Example 1

Samples 1-4 are examples of adhesives containing, as the energy absorbing ingredient, a pigment or an organic dye. These formulations are particularly well suited for use when the core and tubewinding apparatus is equipped with a near infrared energy source as a reactivating means.

Sample 1

An adhesive sample was prepared by blending an EVA, paraffin wax, and hydrocarbon tackifier based hot melt adhesive available from National Starch & Chemical Company (Cool-Lok® 34-2125) with 0.3 wt % of carbon black (Regal 400, Cabot) using a paddle mixer. The adhesive was used to coat the surface of a 3 mil paper substrate and allowed to air dry completely.

Sample 2

0.5 wt % of Epolight 1125, an NIR absorbing dye available from Epolight, was dissolved homogeneously into the base hot melt adhesive (Cool-Lok 34-2125) and uniformly blended with the adhesive with a paddle mixer. The adhesive was used to coat the surface of a 3 mil paper substrate and allowed to air dry completely.

Sample 3

An EVA based waterborne emulsion having the composition comprising 88.0 wt % EVA Emulsion (Dur-o-set E-200, Vinamul), 7.5 wt % Diethylene/Dipropylene Glycol Dibenzoate Plasticizer, 4 wt % water and 0.5 wt % Carbon Black (Plack Pearls 4750, Cabot) was prepared by pre-dispersing the carbon black in the plasticizer using a rotor-stator. The EVA emulsion and water were added using moderate speed axial paddle stirring.

### Example 2

Samples 4-7 are examples of adhesives containing, as the energy absorbing ingredient, a polymer. These formulations are particularly well suited for use when the core and tubewinding apparatus is equipped with a near infrared energy source as a reactivating means.

Sample 4

An ethylene vinyl acetate (EVA) based adhesive available from National Starch and Chemical Company (Product 34-2125). This adhesive contains about 30 wt % of a wax; about 35 wt % of a tackifier; about 35 wt % of EVA polymer; and about 1 wt % of an antioxidant.

Sample 5

A styrene-butadiene rubber (SBR) based adhesive available from National Starch and Chemical Company (Product 34-5610). This adhesive contains about 55 wt % tackifier; about 25 wt % SBR polymer; about 20 wt % diluent oil; and about 1 wt % antioxidant.

Sample 6

An ethylene vinyl acetate based adhesive available from National Starch and Chemical Company (Product No. 40-1103). This adhesive contains about 88 wt % EVA base resin, 8 wt % plasticizer, 0.2 wt % surfactant and water.

Sample 7

An adhesive comprising about 42 wt % of a neoprene latex base resin, about 42% of a tackifier, about 10% of a styrene butadiene polymer and water (available from National Starch and Chemical Company, Product No. 40-801A).

### Example 3

Sample 8 is an example of a water remoistenable adhesive useful when the adhesive is to be reactivated using moisture.

Sample 3

An adhesive comprising 57 parts polyvinyl acetate homopolymer, 8.5 parts polyvinyl alcohol, 3.5 parts humectant, 0.1 parts preservative and 0.1 parts surfactant and 30.8 parts water was prepared and foamed to 28%. The foamed adhesive had a viscosity of 1,200 centipoise, a solids content of 44%, and pH of 5.5. The foamed adhesive was used to coat the surface of a 3 mil paper substrate and allowed to air dry completely.

### Example 4

Adhesive samples 1-3 are evaluated on conventional core winding machinery having a maximum speed of 450 core FPM (100%), modified to comprise an appropriate adhesive reactivation means. The core stock used in all tests is “30# Blue Chip Core Stock”, 3.27″ wide, 0.010″ thick, from US Paper Mills. Cores are produced while initially running the machine at 25% operating speed (approximately 110 feet per minute (FPM)), slowly increasing the operating speed until the machine is not able to produce a finished core without defects or until top operating speed is reached. Results are shown in Table 1.

TABLE 1

| Adhesive | Maximum speed | Fiber Tear | Strength |
|---|---|---|---|
| Sample 1 | 450 FPM | 100% | High |
| Sample 2 | 450 FPM | 100% | High |
| Sample 3 | 450 FPM | 100% | High |
| Sample 4 | 450 FPM | 100% | High |
| Sample 5 | 450 FPM | 100% | High |
| Sample 6 | 450 FPM | 100% | High |
| Sample 7 | 450 FPM | 100% | High |
| Sample 8 | 450 FPM | 100% | High |

Many modifications and variations of this invention can be made without departing from its spirit and scope, as will be apparent to those skilled in the art. The specific embodiments described herein are offered by way of example only, and the invention is to be limited only by the terms of the appended claims, along with the full scope of equivalents to which such claims are entitled.

1. A method for preparing a core or tube comprising contacting a reactivatable adhesive present on at least one surface of at least one ply with moisture to reactivated the adhesive, bringing the reactivated adhesive present on said at least one surface of said one ply together with at least one surface of a second ply whereby said surface of said at least one ply is bonded to said surface of said second ply.

2. The method of claim 1 wherein the adhesive is reactivated using an aqueous mist, spray or steam.

3. The method of claim 2 wherein the adhesive to be reactivated comprises a polyvinyl acetate homopolymer.

4. The method of claim 2 wherein the adhesive to be reactivated is applied to the ply in the foamed state.

5. A core or tube prepared by the method of claim 1.

6. The core or tube of claim 5 which is a single-ply core or tube.

7. The core or tube of claim 5 which is a multi-ply core or tube.

8. The core or tube of claim 7 which is a 2-ply core or tube.

9. The core or tube of claim 5 wherein the core or tube is a consumer core or tube.

10. The core or tube of claim of claim 5 wherein the core or tube is an industrial core or tube.

11. The core or tube of claim 5 wherein the core or tube is used in the tissue, towel, carpet, textile, plastic film, paper, food or industrial storage industry.

12. The tube of claim 5 which is a concrete column forming tube.

13. The tube of claim 12 wherein the concrete column forming tube comprises from about 10 to about 30 plies.

14. An apparatus for manufacturing a core or tube comprising a means for reactivating an adhesive, said reactivating means comprising water.

15. The apparatus of claim 14 wherein said water is provided in the form of a mist, a spray or as steam.

16. The apparatus of claim 14 wherein plies of paper or paperboard are helically wound.

17. The apparatus of claim 14 wherein plies of paper or paperboard are spirally wound.

18. The apparatus of claim 14 for manufacturing a single ply core or tube.

19. The apparatus of claim 15 for manufacturing a multi-ply core or tube.

20. The apparatus of claim 19 for manufacturing a 2-ply core or tube
